(19) United States
(12) Patent Application Publication
(10) Pub. No.: US 2008/0165446 A1
(43) Pub. Date: Jul. 10, 2008

(54) Magnetic Spacing Map Method and Apparatus for a Disk Drive

(76) Inventor: Charles Partee, Lyons, CO (US)

Correspondence Address: PRITZKAU PATENT GROUP, LLC, 993 GAPTER ROAD, BOULDER, CO, 80303, US

(21) Appl. No.: 11/621,758

(22) Filed: Jan. 10, 2007

(51) Int. Cl. G11B 21/02

(52) U.S. Cl. 360/75

(57) ABSTRACT

An exemplary embodiment providing one or more improvements includes a head apparatus clearance control apparatus and method in which a map of disk drive disk is created and used for adjusting the head clearance of a disk drive.

### BACKGROUND

Each year, disk drive manufacturers are faced with producing smaller disk drives with larger storage capacity to meet market demands. One way in which this is accomplished is by increasing the storage density in the magnetic layer of the disk of the disk drive. By increasing the storage density, the disk has more tracks for a given area and each track has more bits. However, increasing the density typically also requires decreasing the magnetic spacing between the magnetic layer in the disk and read/write transducer(s) in a head arrangement for reading and/or writing data to the magnetic layer. This decreased magnetic spacing requires the head arrangement to be closer to a major surface area of the disk during operation which can lead to accidental contact between the head arrangement and the disk surface. These head contacts can damage the head arrangement, the disk surface or both.

The head arrangement is attached with and forms a portion of a slider assembly which moves across a major surface area of the disk to align the transducer with any given track of the major surface area of the disk to read and/or write data on the given track. The slider assembly flies at a fly height above the surface of the disk on an air bearing and the head arrangement is positioned at a head clearance from the disk surface to produce a corresponding magnetic spacing while the slider assembly flies over the disk surface.

Head contact events are generally either non-repeatable events or repeatable events. In non-repeatable events, the head arrangement contacts the disk surface due to a physical shock or has a collision with a movable particle in the drive. Typically, this is a one-time event or something which does not occur on a regular basis. On the other hand, repeatable head contact events can result from the head arrangement contacting a disk anomaly in a particular area of the disk generally every time that the anomaly passes under the slider assembly.

These disk anomalies can be a particle or other item that is fixed to the disk, or can be performance related. Another disk characteristic relates to the planarity of the disk. When the disk is generally defined by an X-Y plane, a variation in the planarity of the disk can cause one or more areas to have different Z-dimensions or other disk characteristic or feature which causes a portion of the disk major surface area to be closer to the head arrangement than other areas. One cause of a Z-dimension variation is where the disk is warped when it is clamped during manufacture. This warping causes the disk to have variations in Z-height for a given track so that in some portions of the track the disk surface is relatively closer to the head arrangement and in other portions of the track the disk surface is relatively further away from the head arrangement. Because of this, as the disk spins under the head arrangement, the disk displays a sort of waviness and the head clearance varies from one circumferential location on the track to another circumferential location on the track; this situation is referred to as fly height modulation. If the head clearance is set too low, then the head arrangement contacts the disk surface at the areas having the relatively larger Z-height.

Head clearance also affects other characteristics of the disk drive in addition to the likelihood of head contacts. One of these characteristics relates to performance of the disk drive when reading and/or writing data to the magnetic layer of the disk, and the accuracy of these processes.

An important factor affecting the accuracy of the read/write processes is the magnetic spacing which is directly related to the head clearance. Decreasing the head clearance reduces the magnetic spacing between the magnetic fields in the magnetic layer of the disk and the transducer in the head arrangement. Generally, smaller head clearances produce relatively greater read/write accuracy while greater head clearances produce relatively lesser read/write accuracy.

When the disk is warped and the drive experiences fly height modulation, the read/write accuracy of the drive varies around the tracks. At circumferential locations where the magnetic spacing is smaller, the read/write accuracy can improve, and at circumferential locations where the magnetic spacing is greater, the read/write accuracy can decline. Prior methods for controlling fly height modulation include attempts to eliminate the modulation by controlling airbearing compliance, contamination, disk clamping distortion and disk morphology, among other things.

Disk drives are also subject to performance variations that are caused by defects or variations in the various layers which affect the way that the data is read or written in certain areas differently than in other areas. These defects can lead to unacceptable bit error rates and signal to noise ratios, among other things. Prior methods to deal with performance variations have involved eliminating the defects in the magnetic layer by better control of the processes and process parameters used to create the various layers.

Devices have been developed for use in adjusting the head clearance and magnetic spacing on a track by track or annular area basis. Such devices are generically referred to as adjustable head arrangements and the techniques associated with them are sometimes referred to as dynamic fly height or fly height on demand. One adjustable head arrangement uses a resistive element, or heater, that is fabricated along with the read/write transducer, is electrically connected to a preamp, and which resides inside or in close proximity to the transducer. A current is supplied by the preamp to energize the resistive element, which causes the films to heat and the volume adjacent to the heater, or nearly so, and including the transducer, to expand. This has the net effect of reducing the separation between the transducer and the disk surface. When the current is removed, the resistive element cools and the transducer moves away from the disk surface. In this manner, the resistive element is used to adjust the magnetic spacing. The resistive element is typically only activated during read and write operations which allows the transducer to remain relatively further away from the disk surface during other times, thereby reducing the possibility of head contact. Other devices can also be used in the adjustable head arrangement, such as piezoelectric devices.

Prior techniques use the adjustable head arrangement to set the head clearance on a track by track basis. This means that the head clearance is set for annular shaped areas in the form of concentric rings defined by a given track or group of tracks on the disk. Setting the head clearance in this way decreases the likelihood of repeatable head contact events for a given annular area. However, while setting the head clearance for an annular area is useful in avoiding head contact for a given track, this technique can unnecessarily cause a reduction in read/write accuracy for the entire track and does not address problems associated with fly height modulation or similar problems.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a mapping apparatus and method are described for use with a disk drive. One example involves a disk drive having a disk that is supported for rotation and having at least one major surface which defines an annular major surface area. The disk drive also having a head arrangement supported for movement relative to the major surface area for use in performing one or both of a write operation to write data to the disk and a read operation to access data from the disk, in cooperation with the rotation of the disk for any given radius of the disk on the major surface area. The head arrangement includes a clearance from the major surface area that is selectively controllable. A map is created that includes a location of at least one point on the major surface area of the disk. The location of the point is characterizable by a radius and a circumference location. The map is used in adjusting the head arrangement clearance as the point approaches the head arrangement on the radius with rotation of the disk.

In another example, a disk drive is disclosed having a disk that is supported for rotation and having at least one major surface which defines an annular major surface area. The disk drive also having a head arrangement supported for movement relative to the major surface area for use in performing one or both of a write operation to write data to the disk and a read operation to access data from the disk, in cooperation with the rotation of the disk for any given radius of the disk on the major surface area. The head arrangement has a clearance from the major surface area that is selectively controllable. A controller comprises a map generator for generating a map that includes a location of at least one point on the major surface area of the disk. The map includes a radius and circumferential location of the point. A memory device is included for storing the map and a head clearance control portion is included for using the map to adjust the head arrangement clearance as the point approaches the head arrangement on the radius with rotation of the disk.

In yet another example, a disk drive is disclosed having a disk that is supported for rotation and having at least one major surface which defines an annular major surface area. The disk drive also having a head arrangement supported for movement relative to the major surface area for use in performing one or both of a write operation to write data to the disk and a read operation to access data from the disk, in cooperation with the rotation of the disk for any given radius of the disk on the major surface area, at a head arrangement clearance from the major surface area that is selectively controllable. A map of the major surface area of the disk is created. The map including at least a first dimension and a second dimension to uniquely identify any given point on the major surface area. At least one item of information is correlated against the map such that the item of information can have a unique value for the given point on the map in relation to the major surface area. The head arrangement clearance is adjusted, based on the map, as the given point approaches the head arrangement with rotation of the disk.

In still another example, a disk drive is disclosed having a disk that is supported for rotation and having at least one major surface which defines an annular major surface area. The disk drive also having a head arrangement supported for movement relative to the major surface area for use in performing one or both of a write operation to write data to the disk and a read operation to access data from the disk, in cooperation with the rotation of the disk for any given radius of the disk on the major surface area, at a head arrangement clearance that is selectively controllable using a clearance setting of the head arrangement. A two dimensional map of the major surface area of the disk is created based on at least one characteristic of the disk. The clearance setting is circumferentially adjusted based on the two dimensional map and said characteristic, for the given radius of the disk as the disk spins in relation to the head arrangement at the given radius.

In addition to the exemplary aspects and embodiments described above, further aspects and embodiments will become apparent by reference to the drawings and by study of the following descriptions.

### BRIEF DESCRIPTION OF DRAWINGS

Exemplary embodiments are illustrated in referenced figures of the drawings. It is intended that the embodiments and figures disclosed herein are to be illustrative rather than limiting.

FIG. 1 is a block diagram of a disk drive control device according to the present disclosure shown along with a disk drive.

FIG. 2 is a plan view of the disk drive showing a disk and adjustable head arrangement of the disk drive shown in FIG. 1.

FIG. 3 is an enlarged cross sectional view of the disk and head arrangement shown in FIG. 2.

FIG. 4 is an enlarged cross-sectional view of a disk and head arrangement showing a protrusion from a disk surface at an area of the disk.

FIG. 5 is an enlarged cross-sectional view of a disk and head arrangement illustrating disk warpage.

FIG. 6 is another enlarged cross-sectional view of a disk and head arrangement illustrating disk warpage.

FIG. 7 is an enlarged cross-sectional view of a disk with another example of an adjustable head arrangement.

FIG. 8 is another enlarged cross-sectional view of the disk and adjustable head arrangement shown in FIG. 7.

FIG. 9 is a graph of overwrite variation for sectors of a disk.

FIG. 10 is a block diagram of a disk drive and testing device.

FIG. 11 is a block diagram of another disk drive control device.

### DETAILED DESCRIPTION

Various modifications to the described embodiments will be readily apparent to those skilled in the art and the generic principles taught herein may be applied to other embodiments. Thus the present invention is not intended to be limited to the embodiment shown but is to be accorded the widest scope consistent with the principles and features described herein including alternatives, modifications and equivalents, as defined within the scope of the appended claims. It is noted that the drawings are not to scale and are diagrammatic in nature in a way that is thought to best illustrate features of interest. Further, like reference numbers are applied to like components, whenever practical, throughout the present disclosure.

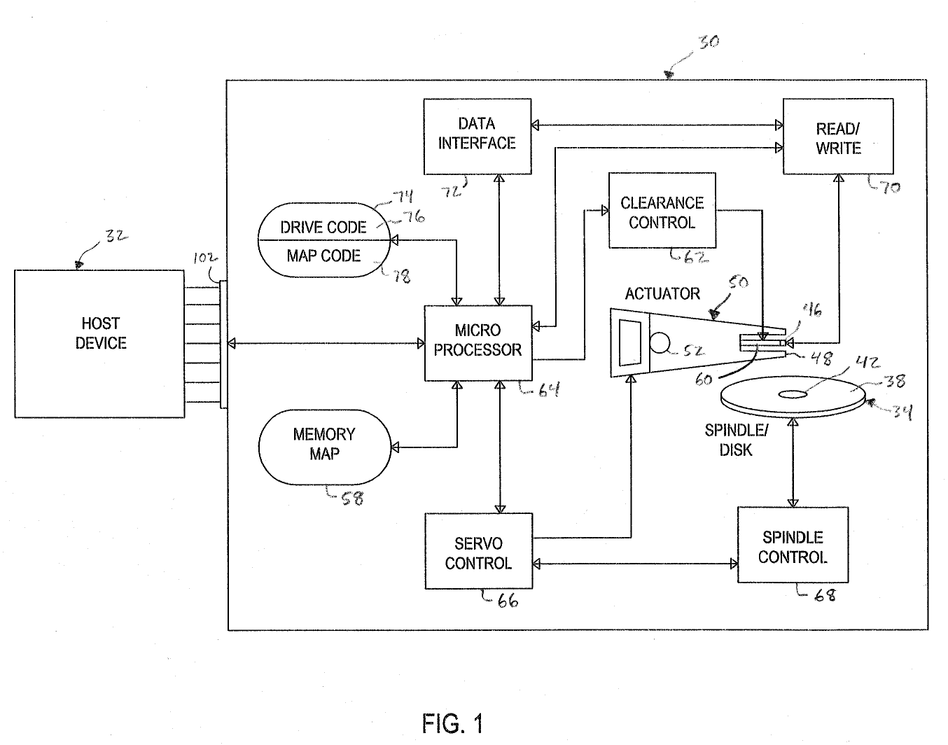

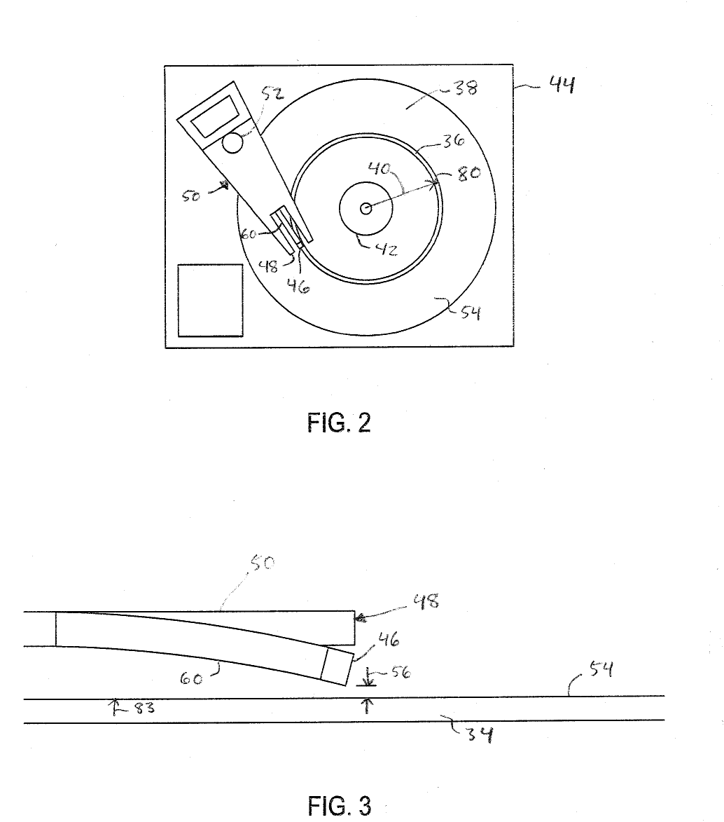

A hard disk drive 30, incorporating one example of a magnetic spacing map according to the present disclosure, is shown in FIG. 1. Hard disk drive 30 is used for magnetically storing data which is utilized by a host device 32. The data is stored in concentric tracks of magnetic media of a disk 34. Disk 34 contains multiple concentric annularly shaped tracks of magnetic media, such as track 36 (FIG. 2), in a major surface area 38 of the disk. Each of the concentric tracks is positioned at a different radius 40 from a spindle 42 which supports disk 34 for rotation relative to a housing 44.

Data is written to and read from the tracks with a head arrangement 46, which can have separate transducers for reading and for writing or may have a single transducer that is capable of both read and write operations. Head arrangement 46 is attached to a slider 48 of an actuator 50 which is pivotable about a pivot position 52 to position the head arrangement above any given track 36. By positioning the head arrangement above a given track and rotating the disk, the head arrangement is able to read and write data to the magnetic media in any area of the major surface area of the disk. Rotation of the disk causes slider 48 to fly above a surface 54 of the disk at a fly-height.

Turning to FIG. 3, in conjunction with FIGS. 1 and 2, unlike some prior devices, the present device utilizes a map of at least a portion of major surface area 38 to predictively control head clearance 56. The map is stored as a memory map 58. Unlike some prior devices, the present device does not try to identify and adjust for obstructions or performance variations on the fly. In the present device, the map is made of the disk which identifies locations in the disk that have anomalies, such as Z-height variations, obstructions or areas where performance variations occur. The map is then used during operation of the disk drive to control head clearance 56 at these locations.

Head arrangement 46 is attached to actuator 50 with a clearance control element 60. Clearance control element 60 shown in FIGS. 3-6 is a piezoelectric element that responds to electrical energy to selectively move or adjust the head arrangement 46 closer or further from disk surface 54 (FIG. 3) for a given height of the slider or fly height. Clearance control element 60 is connected to receive a control signal from a clearance control 62 (FIG. 1) which receives a control signal from a microprocessor 64 for operation with the clearance control 62. In prior devices, head clearance 56 was set to a certain value based on the track that the head arrangement was positioned above. In other words, head clearance 56 was set based on the annular area corresponding to the track. In the present device, the adjustment of the head arrangement 46 is not limited to annularly shaped areas.

Microprocessor 64 accesses the map stored in memory map 58 and uses the map along with information about the location of the head arrangement relative to the disk 34 in controlling the clearance control element 60 to adjust head arrangement 46. Head clearance 56 is a distance between disk surface 82 and head arrangement 46. Magnetic spacing is different from the head clearance in that magnetic spacing is the distance between the head arrangement and the magnetic media in the disk, which is typically covered by a protective layer that forms the disk surface. Therefore, magnetic spacing is generally equivalent to the head clearance plus the distance between the disk surface and the magnetic layer. Fly height, on the other hand, is the vertical distance between slider 48 and disk surface 82.

Microprocessor 64 is also used for controlling various other aspects of the drive. The track position of head arrangement 46 is controlled by a servo control 66 which is itself controlled by microprocessor 64. Servo control 66 is also responsible for controlling disk 34 through a spindle control 68. Disk data is handled under control of microprocessor 64 using a read/write channel 70 in cooperation with a data interface 72.

A memory 74 contains drive code 76 for use by microprocessor 64 in operating drive 30, along with mapping code 78. In the present example, mapping code 78 and a memory map 58 are both connected with microprocessor 64. Memory map 58 stores the coordinates and the head clearances for the major surface areas of the disk, while mapping code 78 contains instructions that are used by microprocessor 64 to control the head clearance based on what is stored in the memory map.

In the present example, head clearance 56 is adjustable not only as a function of radius 40, but also as a function of circumferential location or angle 80. In this way, rather than just having the head clearance set for an annular area, the head clearance can be set for any given area of major surface area 38 of disk 34. The area can be as small as a single point on the disk or can have a boundary or area defined by multiple points. This allows for different head clearances 56 at different circumferential locations in the same track, and also allows for the head clearance to be set for particular areas of the major surface area 38 regardless of the shape or location of the areas on the major surface area.

One of the benefits of having the head clearance adjustment unconstrained by the annular shape of the track is that the head arrangement can be moved relatively closer or further from the disk surface only in the locations where it is required. In other locations, where the head arrangement is not required to be closer or further from the disk surface, the head arrangement can be positioned at a nominal head clearance. The disk drive normally adjusts the head arrangement to the nominal head clearance when reading data from the magnetic layer or writing data to the magnetic layer. The nominal head clearance positions the head arrangement close enough to the magnetic layer to yield acceptable read/write accuracy.

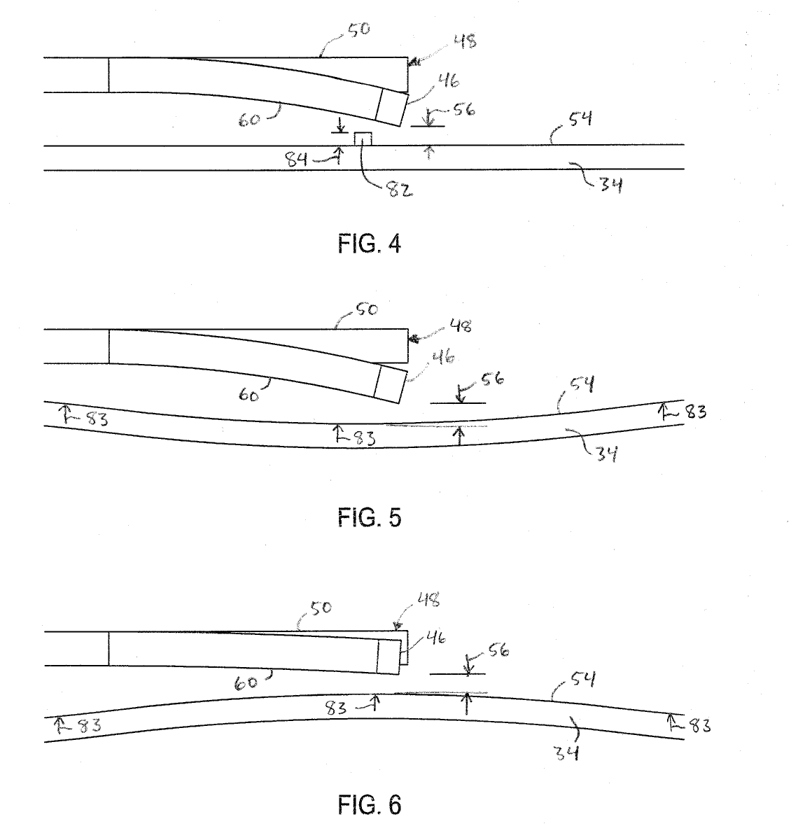

One example of where it is useful to adjust the head arrangement in a single area is shown in FIG. 4 where a particle 82 is fixed to disk surface 54. In this instance, the head arrangement is adjusted away from disk surface 54 to increase head clearance 56. By doing this, the head clearance is greater than a height 84 of the particle so that head arrangement 46 does not contact the particle. The head clearance is increased from a nominal level as the particle approaches the head arrangement until the head clearance is sufficient to cause the head arrangement to clear the particle. When the particle has passed the head arrangement, the head clearance is then decreased back to the nominal level. In this example, the head arrangement is generally positioned at the nominal head clearance except when necessary to avoid contacting the head arrangement with the particle.

In another example, shown in FIGS. 5 and 6, disk 34 is warped which results in the disk having a varying Z-height 83. The Z-height is the value of the Z-dimension if disk surface 54 is in the X and Y dimensions. Disk warping is caused when the disk is clamped to attach the disk to the spindle, or from other causes. When disk 34 is not warped, the Z-height is a constant value from point to point on major surface area 38. When disk 34 is warped, Z-height 83 varies from one point to another on major surface area 38 as illustrated by FIGS. 5 and 6. Because of this, in prior devices where head clearance is adjusted on a track by track or annular basis and if the frequency of the warpage is too high for the entire slider to comply with the changing z-height, then head clearance 56 can modulate with fly height as the disk rotates.

By adjusting the head clearance of the head arrangement based on points or circumferential location, the head clearance, and therefore the magnetic spacing, can be held constant regardless of the variation Z-height 83 and induced fly height modulation from one area or point in major surface area 38 to another. This concept is demonstrated by a comparison between FIG. 5 and FIG. 6. In FIG. 5, head arrangement 46 is above an area of disk surface 54 that has a relatively decreased Z-height in comparison to adjacent areas. To maintain a relatively constant magnetic spacing, head arrangement 46 is adjusted downward, or relatively further away from slider 48 of actuator 50. Then, as the Z-height increases, the head arrangement 46 is adjusted relatively upward, or relatively closer to the working end. By adjusting the position of the head arrangement, a relatively constant head clearance and magnetic spacing is accomplished which addresses the modulation issue.

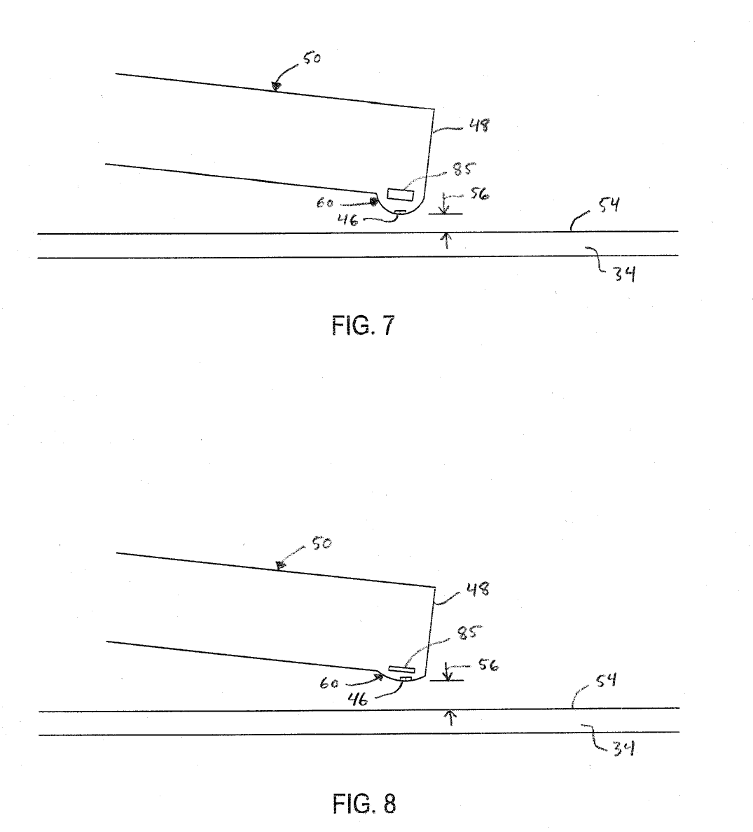

Another example of clearance control element 60 is shown in FIGS. 7 and 8. In this example, the clearance control element 60 includes a resistive heating element 85 to adjust the head clearance. Resistive heating element 85 expands in volume as additional electrical energy is applied to the heating element, as shown in FIG. 7. This expansion causes head arrangement 46 to move relatively closer to disk surface 54 and extend from slider 48 to a greater extent which decreases head clearance. On the other hand, decreasing or removing electrical energy from resistive heating element 85 causes the element to contract, as shown in FIG. 8. The contraction causes the head arrangement 46 to move relatively further from disk surface 54 and closer to slider 48 which increases head clearance.

Adjusting the head clearance on a non-annular basis or based on points is also useful in compensating for performance variations in the disk. In these instances, the performance or accuracy of the read and/or write operations vary from one area of the disk to another. One example of such a performance variation which occurs in disk drives is related to overwrite variation.

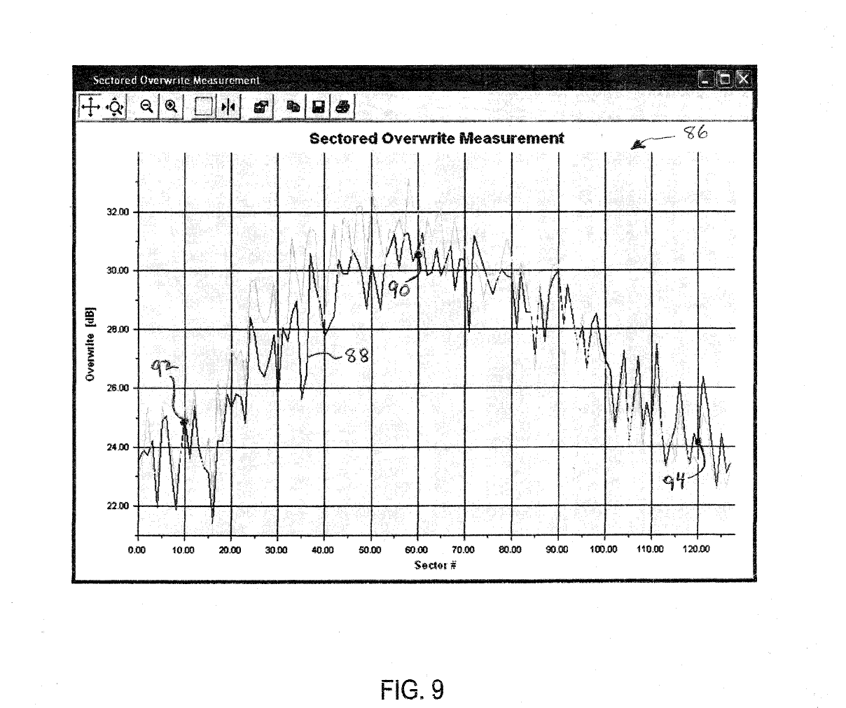

Overwrite variation is the situation where previously stored data on the disk shows through more recently written data to a greater extent in some areas than in other areas. In one example, a sectored overwrite measurement graph 86 shown in FIG. 9 illustrates differences in overwrite between different sectors of the disk. As can be seen by graph 86, overwrite measurement 88 is relatively higher at point 90 in sector 60 than it is at point 92 in sector 10 or point 94 in sector 120. This situation results in a higher bit error rate (BER) in sector 60 than in sectors 10 or 120.

Reducing magnetic spacing is a powerful method for improving performance or compensating for performance variations. In the present example and similar circumstances, where a localized performance metric has dropped below a target threshold, the head clearance can be locally reduced to decrease the magnetic spacing and improve the performance. In this way, adjusting the head arrangement is used to compensate for performance variations that may not be caused by magnetic spacing, such as the overwrite variation previously discussed. Other types of performance variations, such as signal to noise ratio, BER, and others, can also be compensated for by adjusting the head clearance so long as reduced magnetic spacing yields an improved performance.

Reducing the head clearance cannot fully compensate for the performance variation, in some instances. A minimum head clearance can be established and the head clearance is not generally reduced below this minimum because of an unacceptable increase in risk of head to disk contact below this minimum. In one embodiment, in areas where the target threshold performance is not met by reducing the head clearance to the minimum head clearance, the head clearance is not reduced lower than the minimum. In these situations, the head clearance is reduced to the minimum head clearance and the data is used as is, may be compensated for in another manner, or the area of the disk is not used.

In areas where the performance exceeds requirements, the magnetic spacing can be increased for an increased margin of safety from accidental head-disk contact arising from a shock event, a particle or another source.

Head clearance 46 can be set for large areas, small areas, individual point or points or any combination of these as needed. If a large area has similar performance characteristics throughout, for example, then the head clearance may be set to a single value for that area. On the other hand, if different performance characteristics are found in different areas of the major surface area of the disk, then the head clearance may be set to different values when the head arrangement reaches those areas. In one embodiment, head clearance 46 is set for each individual data sector.

The map contained in memory map 58 identifies the areas where the head clearance needs to be adjusted from the nominal head clearance. Mapping the major surface area of the disk can be accomplished in a number of different ways. In one exemplary mapping procedure, the physical characteristics of the disk may be mapped by reducing the head clearance further and further until disk contact is detected. Disk contact can be detected in these circumstances using a position error signal or spin-motor variation. When contact is made, the radius position of the head and the circumferential position of the disk are determined. These positions are stored into memory in the map along with information related to the head arrangement position at the time that the contact was made. From the head arrangement position at contact, the head clearance for the given area can be determined.

Another exemplary mapping procedure is used to detect physical characteristics of the disk to write a single tone around the entire disk and then read and map the variation in read signal strength for the entire disk. The Wallace spacing loss equation,

V=V₀e^{(-2πd/λ)} where V is the instantaneous amplitude, V₀ is the amplitude at d=0, d is the distance between the magnetic layer and the read transducer, and λ is the signal wavelength, can be used to determine the instantaneous magnetic clearance. This information can then be converted to head clearance by subtracting the thickness of the layer between the magnetic layer and the disk surface, or through other methods. The Wallace spacing loss can also be used with the variable gain amplification of servo bursts in the drive in determining head clearances.

Maps containing performance related information are generated by measuring the BER, signal to noise ratio, overwrite defects or other performance related characteristics and correlating this information with locations on the major surface area of the disk. Such performance related information can be determined using known methods.

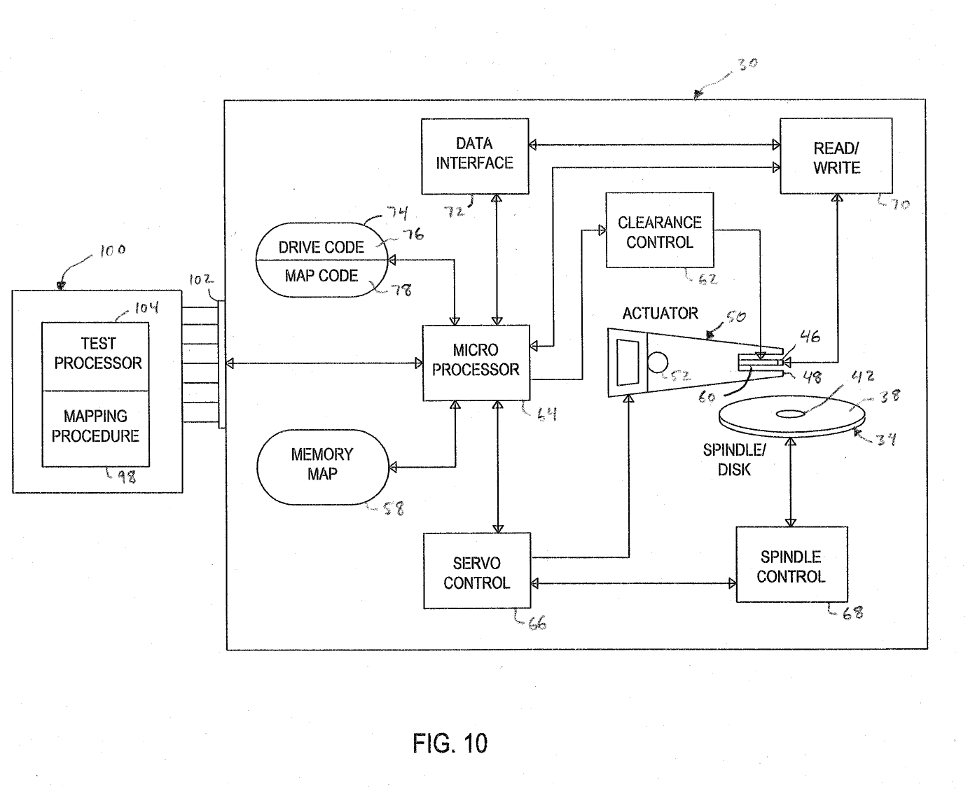

Mapping can be accomplished during a testing procedure during manufacture. In one example, a mapping procedure 98 is stored in a test device 100 which functions as a map generator, as shown in FIG. 10. In this example the mapping procedure is used for controlling disk drive 30 to map the disk 34 as described above with respect to either or both of the physical or performance characteristics of the disk. In this example, the map is created during a test procedure where drive 30 is connected to test device 100 through a connector 102, which can comprise the normal interface of the drive, and a processor 104 operates the mapping procedure 98 to cause drive 30 to map disk 34. In some circumstances, it is beneficial to map only a portion of major surface area 38, while in other circumstances the entire major surface area 38 is mapped. Points of the major surface area can be mapped by data sector, where each data sector is assigned a head clearance and the head clearance of each area is independent of other head clearances.

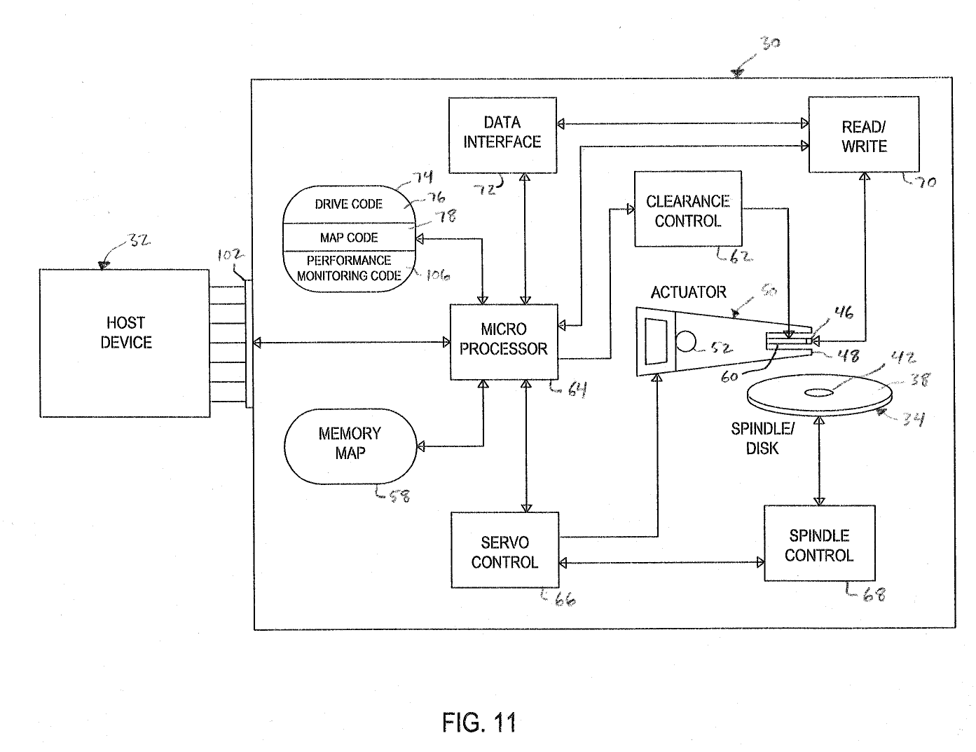

In another example, shown in FIG. 11, a performance monitoring code 106 is stored in memory 74 along with map code 78 and drive code 76. In this instance, microprocessor 64 utilizes the performance monitoring code to track when the performance of the read/write operations drop below the target threshold performance level. In this example, microprocessor 64 and performance monitoring code 106 can be considered to operate as a map generator. The levels of performance can be determined during a plurality of rotations of the disk to determine a plurality of performance levels at one or more points on the disk. One or more of a plurality of determined performance levels are then usable for subsequently adjusting the head clearance in a rotation of the disk. In the areas where the performance drops below the target, the map may be adjusted to improve the performance level to meet the target. This procedure can be used, for example, where the performance level is related to the BER.

The above methods are usable to determine the instantaneous magnetic clearance at any point. Once generated, the map can be tested or refined by repeating the magnetic clearance tests to verify that the variation has been reduced. The map is generated using one or more mapping procedures and is stored in memory map 58. The map contains information related to the desired head clearance and the corresponding coordinates for various locations on the disk. This head clearance information may include information about the energy required to adjust the head arrangement and other information.

The map can be permanently set during a testing or other procedure when the drive is manufactured or the map can be generated by the drive following the manufacture. In either circumstance, the map can be updated on a periodic or as needed basis. In one instance, the map can be automatically updated during the operation of the disk drive to change one or more items of mapped information related to the point. Automatically updating the map can be used to allow the drive to maintain an accurate assessment of the overwrite variation, or other parameters which may change, at one or more points over time.

The information from the map is used with clearance control element 60 to control the head clearance as the head arrangement is moved from track to track and as the disk rotates. Disk 34 spins at 4440 rpm, in the present example. This spin rate results in a range of linear velocities from about 2.5 m/s to about 5.6 m/s. The wavelength of the surface morphology that most strongly influences flyheight modulation of the head arrangement is about 100 to 400 μm. This corresponds to a time constant of approximately 17 to 143 milliseconds, depending on the wavelength and location on the disk. This time constant is longer than the time constant of an appropriately designed heater element type clearance control element (FIGS. 7 and 8), which in the present example is about 250 microseconds. Clamping distortions have a wavelength that is longer, and can therefore be compensated for more easily. Performance variations are also typically long wavelength phenomena which can easily be compensated for. Overwrite variation, as shown in the example in FIG. 7, occurs only once per revolution.

While clearance control element 60 is able to adjust the head arrangement rapidly, a finite amount of time is needed to make the adjustment. Because of this, the head arrangement is adjusted prior to the non-annular disk anomaly area reaching the head arrangement with rotation of the disk. This allows the clearance controller time to adjust the head to a target clearance before or as the area reaches the head arrangement. Thus, the adjustment is predictive in nature. The map may include information relating to the linear velocity of the disk at the radius where the point is located. This, along with the rate at which the head arrangement is adjusted and the amount of adjustment required for the particular area, can be used to determine when to begin adjusting the head clearance to reach the target clearance when the area arrives at the head arrangement. In some instances, the map includes information related to the time required to adjust the head arrangement to the target level from a given head arrangement clearance. The map may also include information relating to the rotational speed of the disk, in these and other instances.

The location of the defect or physical/performance characteristic can be identified using a polar coordinate system such as radius and angle. The location can also be identified using other parameters, which may include tracks, sectors and/or clusters of sectors of the disk. Any suitable type of coordinate system may also be used, such as the Cartesian coordinate system.

The map can be constructed using one or more parameters in addition to the coordinates. For example, the map may contain adjustments in head clearances for areas that have fixed particles in addition to head clearances for areas where the BER is lower than required. Different physical characteristics and performance characteristics can be used in the same map.

The map allows the present device to act in a predictive manner, in contrast to attempting to detect a disk anomaly and then adjust for the anomaly on the fly in time to avoid contacting the anomaly. Adjusting the head arrangement on the fly would require that the anomaly is detected far enough before the head arrangement reaches the anomaly to allow the head arrangement to be adjusted in time to avoid the anomaly. By the time that the anomaly is detected, the head arrangement is likely to be too close to avoid contacting the anomaly. In the present device, by mapping the disk, anomalies can be identified and avoided in a predictive manner. Since the drive determines ahead of time where the head arrangement is going to be located, the head arrangement can be adjusted prior to the head arrangement reaching the location by referring to the map.

Throughout the above examples, disk 34 is shown and discussed with a single major surface area and a single head arrangement. However, it should be noted that the drive may include one or more single or double sided disks supported for rotation by spindle 42 in a stack. In the instances where there are more than one disk surface, multiple head arrangements will be provided to read and write data to magnetic layers in each side. Each of the multiple head arrangements can be independently adjusted for the disk surface with which it operates. It should be appreciated that the examples discussed herein are also applicable to multiple surface areas on one or more platters and multiple head arrangements.

While previous disk drives included the capability of adjusting the head clearance on a track by track basis, these disk drives were not capable of changing the head clearance at the speeds required to implement the device discussed in the present disclosure.

A number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. In a disk drive having a disk that is supported for rotation and having at least one major surface which defines an annular major surface area, and a head arrangement supported for movement relative to the major surface area for use in performing one or both of a write operation to write data to the disk and a read operation to access data from the disk, in cooperation with the rotation of the disk for any given radius of the disk on the major surface area, the head arrangement having a clearance from the major surface area that is selectively controllable, a method comprising:
creating a map including a location of at least one point on the major surface area of the disk, where the location of the point is characterizable by a radius and a circumference location; and
using the map, adjusting the head arrangement clearance as the point approaches the head arrangement on said radius with rotation of the disk.

2. A method as defined in claim 1 wherein the point is associated with an area on the major surface area.

3. A method as defined in claim 1 wherein the disk has a variation from a normal Z-height at the point, and the head arrangement is adjusted on approaching the point during each rotation of the disk to maintain the head arrangement at an approximately constant clearance for the radius of said point, irrespective of said variation, while limiting contact between the major surface area of the disk and the head arrangement.

4. A method as defined in claim 1 wherein the map is used for pre-adjusting the head arrangement clearance prior to the point reaching the head arrangement to allow the head arrangement to assume a target clearance at least as the point reaches the head arrangement.

5. A method as defined in claim 4 wherein the head arrangement includes a clearance adjustment for selectively controlling said clearance using a clearance setting of the head arrangement and wherein the map includes information relating to an amount of pre-adjustment of the clearance setting that is needed in order for the head arrangement to reach the target clearance.

6. A method as defined in claim 4 wherein the map includes information relating to an adjustment time that is required to adjust the head arrangement to the target clearance from a given head arrangement clearance.

7. A method as defined in claim 6 wherein the map includes information relating to a rotational speed of the disk.

8. A method as defined in claim 1 wherein the disk includes a physical variation at the point in the circumferential location of said radius, and said physical variation is not present at a different circumferential location of said radius.

9. A method as defined in claim 8 wherein the physical variation is a protrusion that extends above the major surface area of the disk at the point and the map includes information relating to pre-adjusting the head arrangement clearance upon an approach of the protrusion such that a probability of contact between the head assembly and the protrusion is reduced when the protrusion passes the head arrangement.

10. A method as defined in claim 9 wherein the head arrangement includes a clearance adjustment for selectively controlling said clearance using a clearance setting of the head arrangement and wherein the clearance setting is changed to initiate moving the head arrangement away from the major surface area depending on a predicted time at which the protrusion will reach the head arrangement.

11. A method as defined in claim 1 further comprising:
automatically updating said map, during the operation of the disk drive to change one or more items of mapped information related to the point.

12. A method as defined in claim 1, further comprising:
storing the map in an electronic memory and accessing the electronic memory when using the map.

13. A method as defined in claim 1 wherein the disk includes a performance variation at the point in the circumferential location of said radius for a given head arrangement clearance, said performance variation causing a variation in a level of performance at the point relative to other levels of performance at other circumferential locations of the radius and relating to the ability of the head arrangement to perform the read operation or the write operation or both the read and write operations at the point the method further comprising:
determining levels of performance at the point during a plurality of rotations of the disk; and
using one or more of the plurality of determined performance levels in adjusting the head arrangement clearance in a rotation of the disk subsequent to said plurality of rotations.

14. A method as defined in claim 13, further comprising:
establishing a target performance level, and wherein the head arrangement clearance is adjusted in the subsequent rotation of the disk to cause the performance level at the point to meet the target performance level.

15. A method as defined in claim 13 wherein the performance variation is a bit error rate that is realized when reading data from the disk at the point.

16. A method as defined in claim 15 wherein the head arrangement clearance on approaching said point is increased when the bit error rate at the point is lower than a predetermined threshold bit error rate level.

17. A method as defined in claim 15 wherein the head arrangement clearance on approaching said point is decreased when the bit error rate at the point is higher than a predetermined threshold bit error rate level.

18. A method as defined in claim 13 wherein the performance variation is related to a signal to noise ratio of a signal generated by the read operation.

19. A method as defined in claim 13 wherein the performance variation is related to overwrite variation at the point.

20. A method as defined in claim 19 further comprising:
automatically updating said map, during the operation of the disk drive, to maintain an accurate assessment of the overwrite variation at the point over time.

21. A method as defined in claim 1 wherein the map is created during a test procedure by a manufacturer of the disk drive.

22. A method as defined in claim 1 wherein the map is created for the entire major surface area of the disk.

23. A method as defined in claim 1 wherein the point is within a data sector of the disk.

24. A method as defined in claim 1 wherein the map is created using a Wallace spacing loss equation which locates a variation in Z-height at the point and the head arrangement is adjusted to maintain a constant head arrangement clearance at the point.

25. A method as defined in claim 1, further comprising:
correlating at least one item of information against said map such that the item of information can have a unique value for the point on said map in relation to said major surface area.

26. A disk drive having a disk that is supported for rotation and having at least one major surface which defines an annular major surface area, and a head arrangement supported for movement relative to the major surface area for use in performing one or both of a write operation to write data to the disk and a read operation to access data from the disk, in cooperation with the rotation of the disk for any given radius of the disk on the major surface area, the head arrangement having a clearance from the major surface area that is selectively controllable, a controller comprising:
a map generator for generating a map that includes a location of at least one point on the major surface area of the disk, where the map includes a radius and circumferential location of the point;
a memory device for storing the map; and
a head clearance control portion for using the map to adjust the head arrangement clearance as the point approaches the head arrangement with rotation of the disk on said radius.

27. A controller as defined in claim 26 wherein the point is associated with an area on the major surface area.

28. A controller as defined in claim 26 wherein the head clearance control portion is configured for controlling a resistive element to adjust the head arrangement clearance.

29. A controller as defined in claim 26 wherein said map generator is configured for correlating at least one item of information against said map such that the item of information can have a unique value for the point on said map in relation to said major surface area.

30. A controller as defined in claim 26 wherein the head clearance control portion is configured for controlling a heater element to adjust the head arrangement clearance.

31. In a disk drive having a disk that is supported for rotation and having at least one major surface which defines an annular major surface area, and a head arrangement supported for movement relative to the major surface area for use in performing one or both of a write operation to write data to the disk and a read operation to access data from the disk, in cooperation with the rotation of the disk for any given radius of the disk on the major surface area, at a head arrangement clearance from the major surface area that is selectively controllable, a method comprising:
creating a map of the major surface area of the disk including at least a first dimension and a second dimension to uniquely identify any given point on said major surface area;
correlating at least one item of information against said map such that the item of information can have a unique value for the given point on said map in relation to said major surface area; and
adjusting said head arrangement clearance, based on said map, as the given point approaches the head arrangement with rotation of the disk.

32. A method as defined in claim 31 wherein the point is associated with an area on the major surface area.

33. In a disk drive having a disk that is supported for rotation and having at least one major surface which defines an annular major surface area, and a head arrangement supported for movement relative to the major surface area for use in performing one or both of a write operation to write data to the disk and a read operation to access data from the disk, in cooperation with the rotation of the disk for any given radius of the disk on the major surface area, at a head arrangement clearance that is selectively controllable using a clearance setting of the head arrangement, a method comprising:
creating a two dimensional map of the major surface area of the disk, based on at least one characteristic of the disk; and
circumferentially adjusting said clearance setting, based on said two dimensional map and said characteristic, for the given radius of the disk as said disk spins in relation to the head arrangement at the given radius.

34. A method of claim 33 wherein said map is characterized by a polar coordinate system.

35. A method of claim 34 wherein said map includes a location of at least one point on the major surface of said disk including a radius and a circumferential location of the point and adjusting includes changing the clearance setting as the point approaches the head arrangement with rotation of the disk on said radius.

36. A method as defined in claim 35 wherein the point is associated with an area on the major surface area.

37. A method of claim 33 wherein said map is characterized by a Cartesian coordinate system.
